(19) United States
(12) Patent Application Publication
(10) Pub. No.: US 2016/0058026 A1
(43) Pub. Date: Mar. 3, 2016

(54) PROCESS FOR PRODUCTION OF COLOURLESS VAT MILK AND COLOURLESS CHEESE OBTAINED THEREFROM

(71) Applicant: DMK Deutsches Milchkontor GmbH, Zeven (DE)

(72) Inventor: Sven-Rainer Döring, Zeven (DE)

(21) Appl. No.: 14/839,202

(22) Filed: Aug. 28, 2015

(30) Foreign Application Priority Data
Aug. 30, 2014 (EP) 14182971

(51) Int. Cl. A23C 19/00; B01D 63/10; B01D 61/14; B01D 71/68; B01D 71/06; B01D 61/02; A23L 1/015; B01D 63/08

(52) U.S. Cl. CPC A23C 19/00; A23L 1/0156; B01D 63/10; B01D 63/082; B01D 71/68; B01D 71/06; B01D 61/025; B01D 61/145; A23V 2002/00

(57) ABSTRACT

A process for producing colourless vat milk is proposed, in which
(a) vat milk is subjected to an ultrafiltration and in the course of this a first permeate P1 and a first retentate R1 are produced;
(b) the permeate P1 is subjected to a reverse osmosis and in the course of this a second permeate P2 and a second retentate R2 are produced,
(c) the second retentate R2 is treated with an adsorbent and in the course of this a further retentate R2* is produced,
(d) the resultant retentate R2* is combined with the retentate R1 and the permeate P2.

### FIELD OF THE INVENTION

The invention is in the field of dairy products and relates to a process for the production of colourless vat milk as starting material for the production of colourless cheese.

### PRIOR ART

Milk products are considered in Europe, North America and Australia to be basic foodstuffs. Cheese in this case is distributed particularly in western cultural circles. Up to 5000 cheese varieties are assumed, wherein even cheeses of the same type description differ from cheese factory to cheese factory. The country with the greatest cheese production worldwide is the USA. In East Asia, Africa and South America, cheese plays a minor role. One reason for this is the widespread lactose intolerance among the population.

For producing one kilogram of cheese, depending on the cheese type, between 4 and 16 litres of milk are required. On the basis of the production process, four types may be differentiated:
acid curd cheese,
fresh milk or rennet cheese,
whey protein cheese and
whey cheese.

In the case of conventional cheese, the milk is first heated to 75 degrees and freed from spores in the Bakterofuge. In the next step, the vat milk or cheese milk obtained in this manner is coagulated. This is achieved by adding lactic acid bacteria (for fresh cheese and acid curd cheese) and/or rennet (for hard cheese, semi-hard cheese and soft cheese); here, calcium chloride and pigments are also added. If the milk is solid, the mass is divided with a cheese harp into small pieces: what is termed cheese curd is produced. The smaller the parts become, the better does the liquid whey flow off, and the harder the cheese becomes later. If the curd has achieved an appropriate consistency, it is skimmed off and shaped.

Then, the cheese, depending on the variety, must be ripened for differing times in order to develop the typical aroma and appearance thereof. During the ripening time thereof, the cheese loaves are regularly turned and spread with salt. The salt removes moisture from the cheese, in such a manner that a solid rind is formed. At the same time, salt preserves the cheese and contributes to its taste.

Acid curd cheese is formed when milk is acidified by lactic acid bacteria and as a result the milk protein (casein) is precipitated. This process is termed coagulation. The precipitated casein is separated from the liquid, the whey, and is what is termed fresh cheese. Ripened acid curd cheese can be produced therefrom, which can be refined by special bacteria cultures (red smear) or blue vein mould.

In the production of rennet cheese (also termed fresh milk cheese) the milk protein casein is precipitated by an enzyme mixture of pepsin and chymosin. The property of rennet, which cleaves the milk protein casein in such a manner that the milk coagulates without becoming sour, was already known in antiquity and utilized for cheese production. Most of the known hard or semi-hard cheese types originate from coagulation of fresh milk. Fresh cheese, although typically produced by cultured milk coagulation with the aid of lactic acid bacteria, can be produced using rennet.

Raw milk which has been treated in the above described manner to form vat milk or cheese milk, however, has a high content of riboflavin (I).

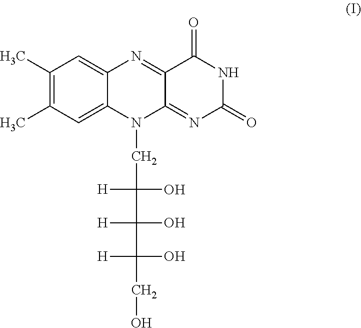 [SMILES: Cc1cc2nc3c(=O)[nH]c(=O)nc-3n(CC(O)C(O)C(O)CO)c2cc1C]

Riboflavin, which also occurs in vegetables such as broccoli, rye, asparagus or spinach, and furthermore in fish, muscle meat, eggs and whole grain products, is also known as lactoflavin or vitamin B2. It is a derivative of pteridine, more precisely of isoalloxazine and the sugar alcohol ribitol. Riboflavin serves as a precursor of flavin coenzymes (FAD, FMN) which play a great role in particular in oxidoreductase, e.g. NADH-dehydrogenase. As a result, it takes a central role in metabolism. Because of its yellow colour, riboflavin is also used as a food dye (E101).

Although riboflavin is therefore fundamentally an interesting natural substance having a multitude of applications, it is undesirable as a milk constituent, since it gives the milk a marked yellow tinge which deepens further during production of cheese from this milk. Even when this colouration is of no importance for the cheese aroma and wholesomeness, many consumers, however, prefer cheese that is virtually colourless and in any case has a very low yellow colouration.

Previous processes for separating off riboflavin have proved either to be too complex or too inefficient. Instead, for the production of colourless cheese, white pigments, especially titanium dioxide are added to vat milk, which is in itself undesirable, against the background of cheese being a natural product.

The object of the present invention was therefore to pre-treat vat milk in a simple manner and free it from discolouring riboflavin, in such a manner that such milk can be used directly for the production of colourless, i.e. non-yellow, cheese. In particular, the conjoint use of white pigments should be superfluous. A second object of the invention is to isolate the valuable riboflavin from the milk in order then to be able to use it further industrially.

### DESCRIPTION OF THE INVENTION

The invention relates to a process for the production of colourless vat milk in which
(a) vat milk is subjected to an ultrafiltration and in the course of this a first permeate P1 and a first retentate R1 are produced;
(b) the permeate P1 is subjected to a reverse osmosis and in the course of this a second permeate P2 and a second retentate R2 are produced,
(c) the second retentate R2 is treated with an adsorbent and in the course of this a further retentate R2* is produced,
(d) the resultant retentate R2* is combined with the retentate R1 and the permeate P2.

Surprisingly, it has been found that by a combination of ultrafiltration, reverse osmosis and adsorption process, the chromophore riboflavin can be virtually completely removed from the vat milk, in such a manner that in a simple manner a starting material is obtained which can be used without further measures, in particular without addition of pigments, for the production of colourless cheese. The valuable riboflavin can meanwhile be isolated in high purity by simple desorption.

### BRIEF DESCRIPTION OF THE DRAWING

The present invention will be described in greater detail with reference to the accompanying drawing which illustrates a flowchart for production of colourless vat milk and isolation of riboflavin.

Vat Milk

The expression vat milk or cheese milk denotes a raw milk which, after pasteurization and fat adjustment, is to be coagulated for the production of cheese, but also yoghurt. Since cheese production was previously predominantly carried out in vats—which today is in part still typical for the production of parmesan—vat milk is a term used synonymously.

In order that raw milk can be used for the production of cheese, it must conform to legal requirements which are laid down in the cheese regulations. Usually, the processing process begins with heating the raw milk by heat exchange with heat carrier media with simultaneous partial heat recovery. Separation into skimmed milk, cream and separator sludge is usually carried out in a pasteurization unit with an integrated separator. In this case the heating is carried so far that a first thermization or pasteurization takes place. After subsequent standardization thereof, the standardized milk is buffered in a tank and the buffered milk taken off from the tank subjected to a second pasteurization by repeated heating and then passed via a Bakterofuge in order to reduce the bacterial count to the extent that is necessary for production and legal requirements.

The heat treatment of the raw milk (“microbe removal”) proceeds preferably in heat exchangers, wherein especially plate heat exchangers have proved to be particularly suitable. On the heat exchangers there is a temperature gradient which, however, is selected in such a manner that the raw milk is heated to a temperature of about 70 to 80° C., and in particular about 72 to 74° C., for a residence time of at least 20 and at most 60 seconds, preferably about 30 seconds.

Separating off solids (“cheese dust”) and also skimming off the fat fraction of about 4% by weight usually proceeds in a downstream component, preferably a separator. Such components are sufficiently known from the prior art. Very widespread in the milk industry are separators from GEA Westfalia Separator GmbH, with which the two steps can be carried out individually or together (http://www.westfalia-separator.com/de/anwendungen/molkereitechnik/milch-molke.html). Corresponding components are also described, for example, in DE 10036085 C1 (Westfalia) and are very well known to those skilled in the art, in such a manner that no explanations are required for carrying out these process steps, since they are considered part of general specialist knowledge.

Ultrafiltration

The expression ultrafiltration is taken to mean a filtration through membranes having a pore size <0.1 μm, whereas a filtration in the case of pore sizes >0.1 μm is usually termed microfiltration. In both cases, these are purely physical, i.e. mechanical, membrane separation processes which operate according to the principle of mechanical size exclusion: all particles in the fluids which are larger than the membrane pores are retained by the membrane. The driving force in both separation processes is the differential pressure between feed and effluent from the filter surface, which is between 0.1 and 10 bar. The filter surface material can, depending on the field of use, consist of stainless steel, plastic, ceramics or textile fabric. There are various forms of the filter elements: candle filters, flat membranes, spiral wound membranes, pocket filters and hollow fibre modules which are all fundamentally suitable for the purposes of the present invention.

Ultrafiltration preferably proceeds at temperatures in the range from about 10 to about 55, preferably 12 to 20° C., wherein the membranes preferably have a pore diameter from about 1000 to about 50 000, and preferably about 5000 to about 25 000 Dalton. Preferably, they are what is termed spiral wound membranes or plate-frame modules made of polysulfone or polyethylene membranes.

Reverse Osmosis

Reverse osmosis is a process in which the feed material is dewatered using a semi-permeable membrane, as a result of which the concentration of valuable milk proteins is increased. The principle is to expose the system to a pressure which is higher than the pressure which results from the osmotic demand for concentration equilibration. As a result, the molecules of the solvent migrate against their “natural” osmotic propagation direction. The process forces them into the compartment in which the dissolved substances are present in less concentrated form. Milk has an osmotic pressure of less than 2 bar, the pressure employed for the reverse osmosis of milk is 3 to 30 bar, depending on the membrane and system configuration used. The osmotic membrane which permits only the carrier liquid (solvent) to pass through and retains the dissolved substances (solute) must withstand these high pressures. If the pressure difference more than compensates for the osmotic gradient, the solvent molecules pass through the membrane, as with a filter, whereas the milk proteins are retained. In contrast to a classical membrane filter, osmosis membranes do not have continuous pores. Reverse osmosis is preferably carried out at a temperature in the range from 10 to 55, preferably 10 to 20° C., with semi-permeable membranes that have a selectivity from 10 to 1000 Dalton.

Adsorption

The riboflavin dissolved in the retentate R2 can be adsorbed in a manner known per se, for example by passage of the retentate over a fixed bed containing an adsorbent or using a column equipped with an adsorbent for solid-liquid adsorption. Suitable adsorbents are, firstly, typical ion-exchange resins, such as, e.g. Lewatit resins, but preference is given to adsorption to activated carbon. Usually, the adsorption is carried out at temperatures in the range from about 10 to about 55° C., and in particular about 12 to about 20° C.

The adsorption of the riboflavin, with a suitable amount of adsorbent and/or sufficient path length, is virtually quantitative. Even if amounts and path lengths may be readily determined by those skilled in the art themselves, without needing to exercise inventive skill therefor, a preferred embodiment, however, consists in filling a column having a diameter of about 10 cm and a length of about 100 cm with activated carbon (particle size e.g. D50=1 mm) and passing the retentate R2 over this with a flow rate of about 10 to about 25 l/h.

Riboflavin Isolation

The invention further relates to a process for obtaining riboflavin, in which
(a) vat milk is subjected to an ultrafiltration and in the course of this a first permeate P1 and a first retentate R1 are produced;
(b) the permeate P1 is subjected to a reverse osmosis and in the course of this a second permeate P2 and a second retentate R2 are produced,
(c) the second riboflavin-containing retentate R2 is treated with an adsorbent and in the course of this a further retentate R2* is produced, and
(d) the adsorbent is treated with a suitable desorbent, the amount of riboflavin dissolved therein is desorbed and is isolated by separating off the desorbent.

The adsorbent is, as already explained above, preferably activated carbon. For the desorption, preferably polar solvents are suitable such as ethanol or isopropyl alcohol which can then be removed under mild conditions, for example on a rotary evaporator, in such a manner that the riboflavin is obtained virtually quantitatively as a yellow to orange residue.

### INDUSTRIAL APPLICABILITY

The invention further relates to the use of vat milk obtainable according to the invention for the production of colourless cheese. Said cheese is obtained in a manner known per se, that is to say by coagulating the vat milk using cultures and/or rennet, separating off the whey, shaping and ripening.

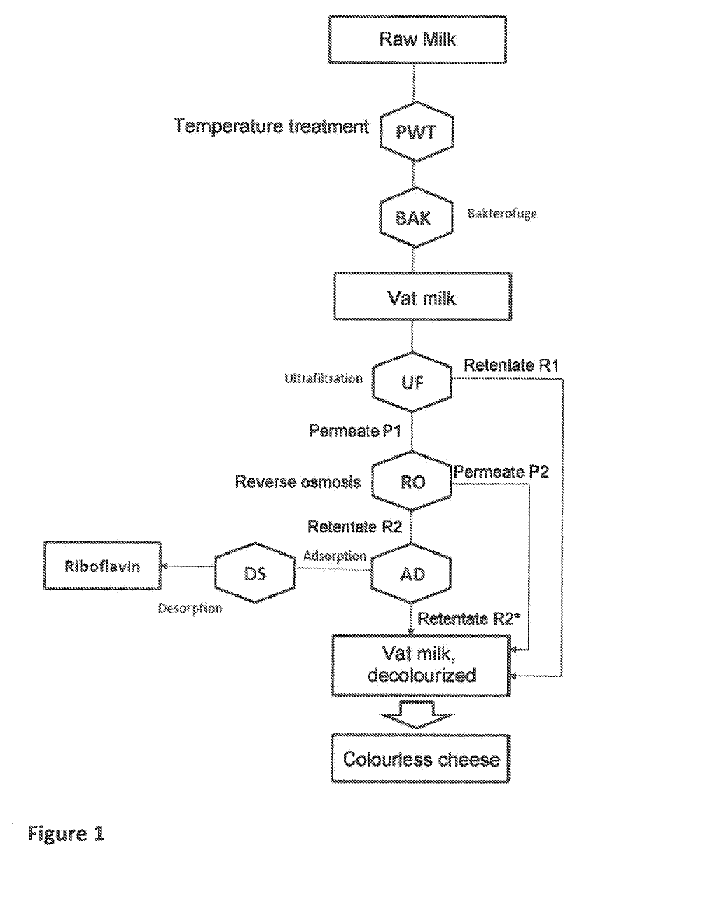

The process is summarized once more in the flowchart as per FIG. 1.

### EXAMPLES

### Example 1

100 l of raw milk were heated to 75° C. for 10 seconds in a plate heat exchanger, pasteurized, and then microbes were removed in a bacterifuge. The vat milk thus obtained was then subjected to an ultrafiltration at 18° C. using a sulfone spiral wound membrane having a pore diameter of 20 000 Dalton. The retentate R1 was run into an intermediate tank and the permeate P1 was subjected at 20° C. to a reverse osmosis using a semi-permeable membrane having a selectivity of 500 Dalton. The permeate P2 was again run into an intermediate tank, whereas the retentate R2 was applied at 20° C. to a column (diameter 10 cm, length 100 cm) packed with activated carbon, wherein the flow rate was about 20 l/h. The previously yellow solution left the column virtually colourless (retentate R2*), was combined with the retentate R1 and with the permeate P2 from the two intermediate tanks and was then available for the production of colourless cheese.

### Example 2

After passage of the entire retentate R2, the then riboflavin-loaded adsorption column was then rinsed at 20° C. first in three portions each time with 10 l of ethanol and then finally with 10 l of isopropyl alcohol. The four yellow-orange fractions were combined and then freed from the solvent in a vacuum. 44 g of riboflavin remained as a bright orange solid.

1. A process for the production of colourless vat milk, comprising the steps of:
(a) subjecting vat milk to ultrafiltration using a membrane having a pore size of about 1,000 to about 50,000 Dalton to obtain a first permeate P1 and a first retentate R1;
(b) subjecting the first permeate P1 to a reverse osmosis using a membrane having a pore size of about 1,000 to about 50,000 Dalton to obtain a second permeate P2 and a second retentate; R2
(c) treating the second retentate R2 with an adsorbent to obtain a third retentate R2*; and
(d) combining the third retentate R2* with the second permeate P2.

2. The process of claim 1, wherein the ultrafiltration (step a) is carried out at a temperature in the range from about 10 to about 55° C.

3. The process of claim 2, wherein the ultrafiltration (step a) is carried out at a temperature in the range from about 12 to about 20° C.

4-5. (canceled)

6. The process of claim 1, wherein the ultrafiltration (step a) is carried out using spiral wound membranes or plate-frame modules made of polysulfone or polyethylene membranes.

7. The process of claim 1, wherein the reverse osmosis (step b) is carried out at a temperature in the range from about 10 to about 55° C.

8. (canceled)

9. The process of claim 1, wherein the adsorbent used is activated carbon.

10. The process of claim 1, wherein the adsorbent used is an ion-exchange resin.

11. The process of claim 1, wherein the adsorption is carried out at temperatures in the range from about 10 to about 55° C.

12. (canceled)

13. A process for obtaining riboflavin, comprising the steps of:
(a) subjecting vat milk to ultrafiltration using a membrane having a pore size of about 1,000 to about 50,000 Dalton to obtain a first permeate P1 and a first retentate R1;
(b) subjecting the first permeate P1 to a reverse osmosis using a membrane having a pore size of about 1,000 to about 50,000 Dalton to obtain a second permeate P2 and a second retentate R2;
(c) treating the second riboflavin-containing retentate R2 with an adsorbent to obtain a third retentate R2*;
(d) treating the adsorbent with a suitable desorbent, to remove the amount of riboflavin adsorbed by the adsorbent; and
(e) isolating the riboflavin by separating the desorbent.

14. The process of claim 13, wherein the adsorbent used is activated carbon.

15. The Process of claim 13, wherein the desorbent used is ethanol or isopropyl alcohol.

16. A process for making colourless cheese, in which the colourless cheese dairy milk obtainable according to claim 1 serves as the starting material.
